(19) United States
(12) Patent Application Publication
(10) Pub. No.: US 2017/0230676 A1
(43) Pub. Date: Aug. 10, 2017

(54) SYSTEM FOR EFFICIENT VIDEO TRANSCODING BASED ON ENCODER DECISIONS EXTRACTION

(71) Applicant: Predrag Filipovic, Princeton Junction, NJ (US)

(72) Inventor: Predrag Filipovic, Princeton Junction, NJ (US)

(73) Assignee: AGORA CREATIVE SOLUTIONS INC., Princeton Junction, NJ (US)

(21) Appl. No.: 14/694,163

(22) Filed: Apr. 23, 2015

Related U.S. Application Data
(60) Provisional application No. 61/996,008, filed on Apr. 28, 2014.

(51) Int. Cl. H04N 19/40; H04N 19/115; H04N 19/159; H04N 19/70

(52) U.S. Cl. CPC H04N 19/40; H04N 19/70; H04N 19/115; H04N 19/159; H04N 19/184

(57) ABSTRACT

A method and apparatus of a system for efficient video transcoding based on encoder decisions extraction. In one embodiment, the method comprises removal of “Residual Data” thus extraction of “Encoding Decisions” En from coded video content Cn at resolution Sn, rate Bn that was originally constructed by decoding content C0 at resolution S0, rate B0, than scaled and encoded into content Cn. The content C0 and “Encoding Decisions” En are used by re-coder to reconstruct, perfectly if required, content Cn by utilizing “Encoding Decisions” En in the process equivalent to encoding thus producing transcoded content Cn of higher quality and with far smaller computational complexity then transcoder with full decode/encode cycle.

### CROSS-REFERENCE TO RELATED APPLICATIONS

This application claims benefit or U.S. provisional patent application No. 61/996,008 filed Apr. 28, 2014 which are herein incorporated by reference.

### BACKGROUND OF THE INVENTION

Field of the Invention

Embodiments of the present invention generally relate to encoded video data processing and distribution systems and, more particularly, to apparatus and method and supporting system for transcoding video data content from one particular resolution and/or rate, to a content with different resolution and/or rate.

Description of the Related Art

As is well known in the art, video content is encoded into digital representation for storage, transmission and ultimately playback. Some well known encoding methods are: MPEG2, H.264 and HEVC. Broadly speaking, these encoding methods remove redundancies from the original content in order to produce representation of smaller size that facilitates more efficient handling.

Video encoding methods produce data that can be generally divided into two categories: (1) “Encoding Decisions” and (2) “Residual Data”. In order to minimize size of resulting content, video encoders: (i) find similarities between spatial or temporal subsets of data (e.g. motion vectors, common properties of neighboring blocks of pixels); (ii) select appropriate coding structure and methods from pre-determined options; and (iii) construct information required for content reconstruction, decoding. These can be called “Encoding Decisions” (e.g. content of SPS, PPS, SEI, Slice Headers and parts of Slice Data for H.264 codec) and their derivation is computationally extensive. The “Residual Data” in absence of “Encoding Decision” contains absolute values of multimedia samples. When “Encoding Decisions” include prediction of current samples or data elements based on previously decoded subsets of data, “Residual Data” contains representation of the difference between said prediction and current samples under consideration.

Video delivery prior to rise of the Internet has been based on the broadcast principle: deliver content at one resolution and rate to all users. Internet and wireless networks (cell, local, wide-area) as well as proliferation of playback devices (from cell phones, pads to video screens) of various sizes and capabilities, brought forth requirements for delivery of content at various resolutions and rates. Furthermore, in order to compensate for the dynamic nature of network and computational resources (e.g. available bandwidth, CPU or memory allocated for processing), content providers need systems that can dynamically change resolution and/or rate of delivered content while it is being consumed by users.

Typical solutions for the above mentioned requirements fall into three broad categories: (1) encode and ready for delivery multiple versions (resolutions, rates) of digital content; (2) encode content as set of segments or hierarchy of resolutions and rates (layers), each of which can be extracted from the totality of content (scalable video); and (3) encode content at fixed (preferably highest) resolution and rate then dynamically transcode (decode then re-encode) to required resolution and rate before delivery to playback destination.

Approach (1) provides highest ratio of encoding quality vs. content size but requires large amount of storage and network bandwidth utilization to keep and transfer multiple versions of the same content thus resulting in high cost, and delivery that is sensitive to network delays that can undermine proper user experiences.

Approach (2) known as “Scalable Video”, was designed to address the need for multiple resolutions and rates. These systems never achieved significant adoption due to the fact that the resulting content size is significantly larger then non-scalable maximum resolution option even for minimum number of multi-resolution layers. Moreover, the quality of playback of each layer (resolution, rate) that can be extracted from scalable content is lower then the quality that can be achieved by non-scalable representation for the same requirements.

Approach (3) requires large quantities of expensive equipment since multimedia encoding/transcoding is highly computationally intensive operation (1-2 orders of magnitude more intensive then multimedia decoding) and also contributes to lower quality of displayed content due to lossy nature of encoding/transcoding. The prior art and common practices in transcoding domain were mostly focused on improvements of transcoding speed through better guess for the initial search point (limit search area) based on results from data at different resolutions or rates.

While the above mentioned art and practices do address requirements for multiple resolutions and data rates delivery, these approaches incur unnecessarily high cost at either storage or core network or at the network edge (for distributed delivery systems), or sacrifice quality in order to control said costs. As such, there is a need in the art for method and apparatus (system) that will address requirements for multiple resolutions and data rates delivery that improves cost structure and quality of delivery without sacrificing multimedia playback quality.

### SUMMARY OF THE INVENTION

Various embodiments of the present invention generally include a method and apparatus for efficient system for efficient video transcoding based on encoder decisions extraction. In one embodiment, the method comprises (i) separation of “Encoding Decisions” En and “Residual Data” Rn (e.g. “residual( )” in H.264 specification) from content Cn encoded at resolution Sn (including but not limited to spatial dimensions, pixel bit-length, chroma option), rate Bn, where said content was computed by known and pre-selected video scaling method Mn from content C0 encoded at resolution S0, rate B0; (ii) optional processing and delivery of content C0 and “Encoding Decisions” En of content Cn to transcoding apparatus; (iii) re-coding by re-computation of “Residual Data” Rn from content C0 scaled by Mn and “Encoding Decisions” En, resulting in (optionally) perfect re-construction of content Cn. Said transcoding method operates on either the whole content or selected content parts.

In one embodiment, the apparatus comprises of: (1) system for separation of “Encoding Decisions” En and “Residual Data” Rn from content Cn encoded at resolution Sn, rate Bn; (2) system for optional processing and delivery of content C0 and “Encoding Decisions” En; (3) system for (optionally) perfect re-construction of content Cn from “Encoding Decisions” En and content C0. Said transcoding apparatus/system operates on either the whole content or on selected content parts.

In one embodiment, the system (1) from said embodiment apparatus, decodes content C0, scales it to Pn with scaling method Mn, then encodes to content Cn. Said system then removes all “residual( )” portions from H.264 video content Cn where the remaining data constitutes “Encoding Decisions” En. The re-construction system (3) from said embodiment apparatus, decodes content C0, scales it to Pn with the same method Mn used to construct Cn from C0, applies decoded En to Pn and re-constructs content Cn. The re-construction system has decoding complexity which is orders of magnitude smaller then encoding complexity resulting in transcoding system of this embodiment that is far more efficient then full decode/re-encode systems of known art.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and specific video coding examples selected for ease of understanding and are therefore not to be considered limiting of its scope, for the invention admits other video coding methods and may admit to other equally effective embodiments.

FIG. 1 is an illustration of a complete system for efficient video transcoding based on encoder decisions extraction according to one or more embodiments.

FIG. 2 is an illustration of a system for separation of “Encoding Decisions” and “Residual Data” for an example case of H.264 encoded content according to one or more embodiments.

FIG. 3 is an illustration of a system for re-coding (re-construction) of video encoding at particular resolution and rate, for an example case of H.264 encoded content. FIG. 3 illustrate said system for re-coding by comparison between essential parts of “standard” H.264 encoding vs. said re-coding with available “Encoding Decisions” En according to one or more embodiments.

### DETAILED DESCRIPTION

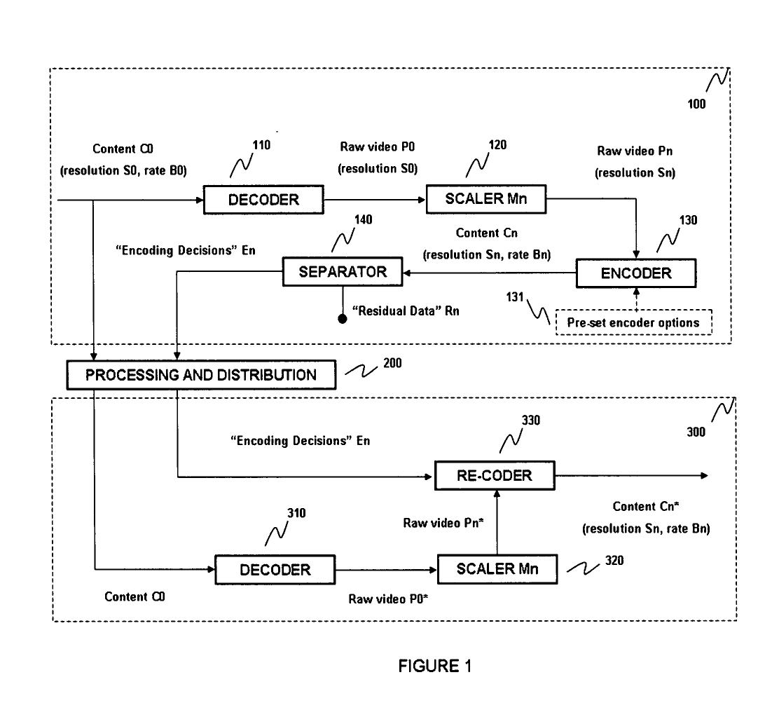

FIG. 1 depicts a system consisting of blocks 100 (“send” side), 200 (“conduit”) and 300 (“receive” side) for efficient video transcoding in accordance with embodiments of the present invention. Encoded video content C0 of particular resolution S0 and rate B0 is decoded by decoder 110 and produces sequence of raw video frames P0. Said sequence P0 is then scaled by pre-selected scaling method Mn in a scaler 120 to a required resolution Sn, whereby term “resolution” includes: frame dimensions and/or number of bits per pixel and/or chroma format and/or any other characteristic associated with raw sequence of video frames. The resulting sequence Pn is processed by encoder 130 that produces encoded content Cn based on Pn and set of encoder options 131. Process flow from system input C0 to encoder 130 output Cn represents well know art of video transcoding and it is envisioned to be performed off-line (not necessarily live nor real-time) in this example embodiment.

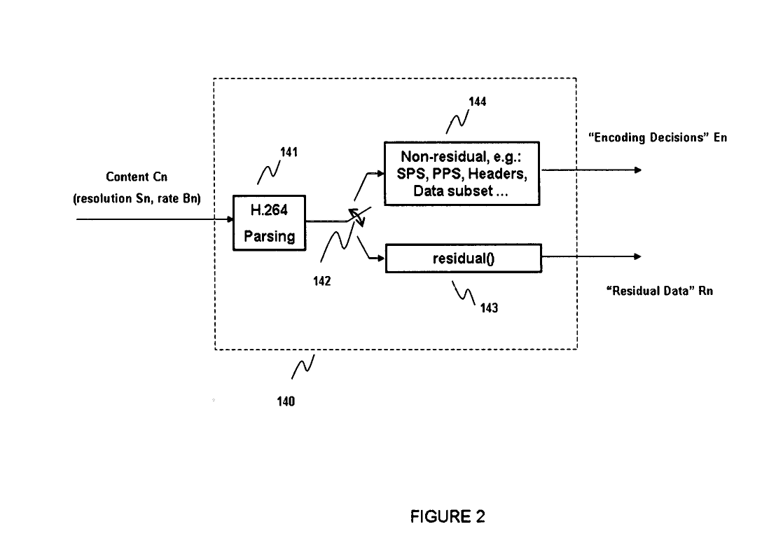

Content Cn is further processed by separator 140, details of which are illustrated in FIG. 2, which separates “Encoding Decisions” En from “Residual Data” Rn and outputs content containing “Encoding Decisions” En only. Said content En and input content C0 or selected and matching parts of these contents are then additionally processed and transmitted by system 200 that includes but is not limited to known data compression and network transmission formats and protocols.

Content C0 and “Encoding Decisions” En are inputs to the receiving side 300 of the system illustrated herein. Encoded video content C0 is decoded by decoder 310, identical to the decoder 110 by decoding specification and/or by design and produces sequence of raw video frames P0*. Scaler 320 that processes P0* is identical to scaler 120 thus ensuring that resulting raw sequence Pn* on the receiving side 300 is identical to Pn from the sending side 100.

The resulting sequence Pn* from system 300 and received content En are inputs to re-coder 330, details of which are illustrated in FIG. 2, which produces encoded content Cn* that can be if required, identical to corresponding content Cn from the sending side 100. Process flow in sub-system 300, from system input C0 and En to re-coder's 330 output Cn* is envisioned to be performed either off-line or live (in real-time) in this example embodiment.

FIG. 2 depicts a system 140 for separation of “Encoding Decisions” En and “Residual Data” Rn in accordance with embodiments of the present invention. For purposes of ease of understanding, the illustration depicted on FIG. 2 represents a block diagram of separator 140 for the case of H.264 encoded content where “Residual Data” Rn corresponds to “residual( )” block as described and used by H.264 standard. Content Cn is processed through H.264 standard compliant parser 141. The switch element 142 identifies H.264 “residual( )” data section (“Residual Data” Rn) and directs its transfer to block 143 that collects and optionally discards “Residual Data” Rn. When switch element 142 identifies H.264 data that is not “residual( )”, it directs its transfer to block 144 that organizes said data into “Encoding Decisions” content En.

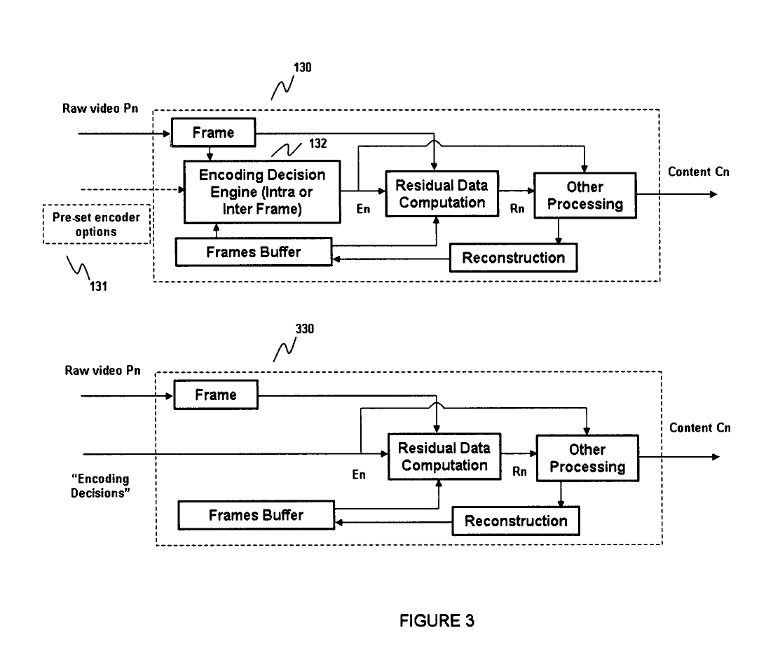

FIG. 3 depicts a system 330 for re-coding of content Cn in accordance with embodiments of the present invention. Notably, FIG. 3 depicts encoder 130 and re-coder 330 for purposes of easier understanding of system 330 by comparison with “standard encoder” 130. The illustration depicted on FIG. 2 represents re-coding and encoding for the case of H.264 for purposes of ease of understanding. Additionally, block diagrams for both 330 and 130 are only sketches of encoding sub-system deemed essential for understanding embodiments of the present invention.

System 130 on FIG. 3 illustrates “top level” method and apparatus of standard H.264 encoder. Inputs to Encoding Decision Engine block 132 are frame of raw data under consideration, pre-set encoding parameters 131 and buffered frames that were previously encoded then reconstructed (decoding equivalent). As it is known in the art, block 132 decides if frame is to be coded independently (intra) or as difference from frames in the frame buffer (inter), then performs computationally extensive “search” using any method known in the art to select “optimal” encoding structure, parameters and data sub-set for reference (“Encoder Decisions” En). As it is known in the art, “Residual Data” Rn is then computed by straight-forward mathematical operations as specified by En on data sub-sets from frame and frame buffer that are also specified by En. Content Cn is formed upon additional processing of En and Rn as is well known in the art.

System 330 on FIG. 3 illustrates “top level” method and apparatus of re-coder in accordance with embodiments of the present invention. It is described here in terms of difference between re-coder 330 and standard H.264 encoder 130. Re-coder 330 does not have Encoding Decision Engine block 132 and does not require pre-set encoding parameters 131 because all “Encoder Decisions” En are passed from system 100 through system 200 to system 300, and specifically to re-coder 330. The remaining computational and data flow of re-coder 330 is identical to that of standard H.264 encoder 130.

The foregoing description of embodiments of the invention comprises a number of elements, systems, devices, circuits and/or assemblies that perform various functions as described. These elements, systems, devices, circuits and/or assemblies are exemplary interpretations of means for performing their respectively described functions.

While the foregoing is directed to embodiments of the present invention, other and further embodiments of the invention may be devised without departing from the basic scope thereof, and the scope thereof is determined by the claims that follow.

1. A method/system for efficient video transcoding based on encoder decisions extraction comprising: H.264 decoder, video scaler, H.264 encoder, separator system that extracts “residual( )” portion of H.264 from encoded content, processing and distribution system, H.264 decoder equivalent to said H.264 decoder, video scaler equivalent to said scaler, re-coder apparatus, wherein video content C0 or portion thereof encoded with H.264 at specific bit-rate and specific resolution that includes but its not limited to: video frame size, specific number of bits per pixel, specific chroma format, frame rate is decoded by said decoder, wherein resulting raw video sequence is scaled to a different resolution by scaler or passed through scaler retaining the same resolution, wherein resulting scaled raw video sequence is encoded to either different resolution or different bit-rate or both by encoder based on said raw sequence and present encoding option, wherein resulting coded content Cn is processed by a separator that extracts “residual( )” portion per H.264 specification from said coded content thus producing output En that contains only “Encoding Decisions”, wherein both the initial video content C0 and said output En or portions of these are, individually or jointly, optionally further processed by any know and/or future art and distributed to or through one or more destinations by any know and/or future art, wherein receiving system receives said C0 and said output En or corresponding portions of these, wherein said content C0 or portion thereof is decoded by the decoder equivalent to previously utilized H.264 decoder, wherein resulting raw video sequence is scaled to a resolution identical to previously utilized resolution for previously utilized scaler or passed through scaler equivalent to previously utilized scaler, where in resulting raw video sequence at the output of this scaler is identical to resulting raw video sequence at the output of previously utilized scaler, wherein re-coder accepts resulting scaled raw video sequence and said “Encoding Decisions” En or said corresponding portion thereof as input, wherein re-coder performs all functions of H.264 encoder except those including but not limited to: inter/intra coding decisions, motion vector search, selection of encoding modes, that would eventually produce information identical to information received by “Encoding Decisions” En input, thus in essence, re-coder reconstructs previously removed “residual( )” data portion and performs further H.264 processing based on “encoding decisions” En, wherein resulting content Cn* can be, if so desired, identical to said content Cn.

2. The method/system of claim 1 wherein video codec is not H.264 but any other video codec in the preset and future art that is equivalent to H.264 in the sense that encoded video content contains separable “Residual Data” that is substantially similar to “residual( )” data portion of H.264 content, and thus contains separable “Encoding Decisions” substantially similar to said “Encoding Decisions” En from claim 1, wherein all comprising sub-systems from claim 1 perform identical or equivalent functions for said other video codec that said sub-systems performed for H.264 in claim 1.

3. The method/system of claim 2 wherein any or all comprising sub-systems are merged and/or divided into different sub-systems where in at least one of said different sub-systems performs function identical or equivalent to function of said separator or at least one of said different sub-systems performs function identical or equivalent to function of said re-coder.
